(19) United States
(12) Patent Application Publication
(10) Pub. No.: US 2021/0192480 A1
(43) Pub. Date: Jun. 24, 2021

(54) STORE SYSTEM, INFORMATION PROCESSING DEVICE AND CONTROL PROGRAM THEREFOR, AND CHECKOUT MACHINE AND CONTROL PROGRAM THEREFOR

(71) Applicant: TOSHIBA TEC KABUSHIKI KAISHA, Tokyo (JP)

(72) Inventors: Tsuyoshi GOTANDA, Tokyo (JP); Kenya HIRAMATSU, Tokyo (JP); Akiko HIRAYAMA, Yokohama (JP); Shiori HIDAKA, Fujisawa (JP)

(73) Assignee: TOSHIBA TEC KABUSHIKI KAISHA, Tokyo (JP)

(21) Appl. No.: 16/991,854

(22) Filed: Aug. 12, 2020

(30) Foreign Application Priority Data
Dec. 20, 2019 (JP) 2019-230393

(51) Int. Cl. G06Q 20/20; G06Q 20/32; G06Q 20/40; G06K 7/00

(52) U.S. Cl. CPC G06Q 20/201; G06Q 20/322; G06Q 20/4037; G06Q 20/209; G06K 7/0021; G06Q 20/202; G06Q 20/204

(57) ABSTRACT

A store system includes an information processing device and a checkout machine, which may be comprised by at least one processor. The information processing device acquires a balance of electronic money. The information processing device calculates a price every time a purchased commodity is registered. The information processing device correlates charge instruction information of the electronic money with a mobile terminal and stores the charge instruction information when a predetermined condition holds between the balance of the electronic money and the price. The checkout machine selects, when receiving a payment instruction from the mobile terminal not correlated with the charge instruction information, a payment mode for receiving an input of data concerning payment and selects, when receiving the payment instruction from the mobile terminal correlated with the charge instruction information, a charge mode for receiving an input of data concerning charging of the electronic money.

### CROSS-REFERENCE TO RELATED APPLICATION

This application is based upon and claims the benefit of priority from Japanese Patent Application No. 2019-230393, filed in Dec. 20, 2019, the entire contents of which are incorporated herein by reference.

### FIELD

Embodiments described herein relate generally to a store system, an information processing device and a control program therefor, and a checkout machine and a control program therefor.

### BACKGROUND

In recent years, various store systems have been devised in which a customer registers purchased commodities using a mobile terminal (a cart terminal, smartphone, or the like) while purchasing commodities in a selling floor to simplify registration operation for the purchased commodities during checkout.

In such store systems, if the customer using the mobile terminal, referred to as a user, finishes the registration of the purchased commodities and moves to a setting place of a checkout machine, a payment method selection screen for urging the user to select a payment method such as cash, a credit card, or electronic money is displayed on a touch panel of the checkout machine. First, the user desiring to charge electronic money selects the “electronic money” as the payment method. Then, the screen is switched to a payment screen for the electronic money. Since a charge button is displayed on the payment screen other than an electronic money payment button, the user touches the charge button. Then, the screen is switched to a charge screen. Therefore, the user designates a charge amount and performs depositing. If the user finishes the charging of the electronic money in this way, the screen returns to the payment method selection screen. Therefore, the user selects the payment method.

In this way, a complicated operation is requested if the user charges the electronic money and then performs settlement in the checkout machine. Therefore, there is a concern that the operation requires time and the settlement is delayed.

### DESCRIPTION OF THE DRAWINGS

FIG. 1 is a schematic diagram illustrating a schematic configuration of a store system according to at least one embodiment;

FIG. 2 is a block diagram illustrating a main part circuit configuration of a mobile terminal;

FIG. 3 is a perspective view illustrating an example of a shopping cart in which a mobile terminal is provided;

FIG. 4 is a block diagram illustrating a main part circuit configuration of a store server;

FIG. 5 is a schematic diagram illustrating an example of a checkout machine table;

FIG. 6 is a block diagram illustrating a main part circuit configuration of a virtual POS server;

FIG. 7 is a schematic diagram illustrating an example of a purchase registration list;

FIG. 8 is a schematic diagram illustrating an example of purchased commodity data;

FIG. 9 is a block diagram illustrating a main part circuit configuration of a checkout machine;

FIG. 10 is a flowchart illustrating a main part control procedure of a processor in the mobile terminal;

FIG. 11 is a flowchart illustrating a main part control procedure of a processor in the virtual POS server;

FIG. 12 is a flowchart illustrating a main part control procedure of the processor in the virtual POS server;

FIG. 13 is a flowchart illustrating a main part control procedure of the processor in the virtual POS server;

FIG. 14 is a flowchart illustrating a main part control procedure of the processor in the virtual POS server;

FIG. 15 is a flowchart illustrating a main part control procedure of a processor in the checkout machine;

FIG. 16 is a schematic diagram illustrating an example of a purchase registration screen displayed in the mobile terminal;

FIG. 17 is a schematic diagram illustrating an example of a charge selection screen displayed in the mobile terminal;

FIG. 18 is a schematic diagram illustrating an example of a checkout barcode and a checkout machine guidance screen displayed in the mobile terminal;

FIG. 19 is a schematic diagram illustrating an example of a charge amount input screen displayed in the checkout machine;

FIG. 20 is a schematic diagram illustrating an example of a cash deposit screen displayed in the checkout machine; and

FIG. 21 is a schematic diagram illustrating an example of a payment method selection screen displayed in the checkout machine.

### DETAILED DESCRIPTION

An object of at least one embodiments is to provide a store system that can reduce the number of operation steps when electronic money is charged in a checkout machine.

According to at least one embodiment, a store system includes an information processing device and a checkout machine which may be comprised by at least one processor. The information processing device includes an acquiring unit, a calculating unit, and a storing unit. The acquiring unit acquires a balance of electronic money. The calculating unit calculates a price every time a purchased commodity is registered. The storing unit correlates charge instruction information of the electronic money with a mobile terminal and stores the charge instruction information when a predetermined condition holds between the balance of the electronic money and the price. The checkout machine includes a receiving unit and a mode selecting unit. The receiving unit receives a payment instruction from the mobile terminal. The mode selecting unit selects, when receiving the payment instruction from the mobile terminal not correlated with the charge instruction information, a payment mode for receiving an input of data concerning payment and selects, when receiving the payment instruction from the mobile terminal correlated with the charge instruction information, a charge mode for receiving an input of data concerning charging of the electronic money.

At least one embodiment is explained below with reference to the drawings. In this embodiment, a tablet terminal (a so-called cart terminal) attached to a shopping cart is used as a mobile terminal.

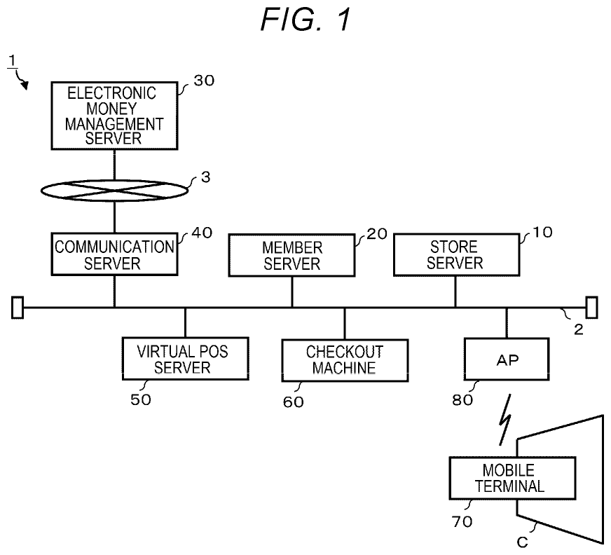

FIG. 1 is a schematic diagram illustrating a schematic configuration of a store system 1 according to at least one embodiment.

The store system 1 includes a store server 10, a member server 20, an electronic money management server 30, a communication server 40, a virtual POS server 50, a checkout machine 60, a mobile terminal 70, and an access point 80. The store server 10, the member server 20, the communication server 40, the virtual POS server 50, the checkout machine 60, and the access point 80 are connected to a network 2 such as a LAN (Local Area Network). The electronic money management server 30 is connected to the communication server 40 via a dedicated network 3.

The mobile terminal 70 is a device that enables a user, who is a purchaser, to input data relating to registration of a commodity that the user is about to purchase, referred to as a purchased commodity by himself or herself. The mobile terminal 70 is provided in a shopping cart C. In the following explanation, the shopping cart C is simply referred to as cart C. Mobile terminals 70 are respectively provided in a plurality of carts C. The cart C is an example of a carrier that carries the purchased commodity of the user, who is a user of the cart C.

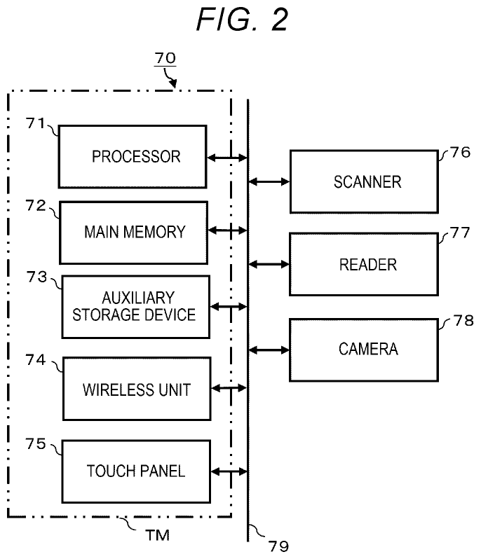

The mobile terminal 70 includes a wireless unit 74 (see FIG. 2). The mobile terminal 70 performs wireless communication with the access point 80. The access point 80 relays communication between the devices connected to the network 2, that is, the store server 10, the member server 20, the electronic money management server 30, the communication server 40, the virtual POS server 50, and the checkout machine 60 and the mobile terminal 70. Only one access point 80 is illustrated in FIG. 1. However, two or more access points 80 may be provided according to the size and the like of a store.

The checkout machine 60 is a device that enables a store clerk or the user to make payment of the purchased commodity. The number of checkout machines 60 is not particularly limited.

The store server 10 manages a commodity database. The commodity database saves a commodity data record describing data of commodities sold in the store. The commodity data record includes items such as a commodity code, a commodity name, and a price. The commodity code is commodity identification data set for each of the commodities in order to individually identify the commodities. Usually, barcodes representing commodity codes are attached to the commodities.

The member server 20 manages a member database. The member database saves a member data record describing member data for each of members. The member data record may include a member ID, a name, sex, a mail address, and an electronic money user ID. The member ID is an identification code of the member. The electronic money user ID is issued when a customer purchases prepaid electronic money.

The electronic money management server 30 is a computer that manages a balance of electronic money for each of electronic money user IDs.

The communication server 40 executes data communication processing performed via the dedicated network 3 between the checkout machine 60 or the virtual POS server 50 and the electronic money management server 30.

The virtual POS server 50 cooperates with the mobile terminal 70 and causes the mobile terminal 70 to operate to realize functions of a POS terminal.

FIG. 2 is a block diagram illustrating a main part circuit configuration of the mobile terminal 70. The mobile terminal 70 may include a processor 71, a main memory 72, an auxiliary storage device 73, a wireless unit 74, a touch panel 75, a scanner 76, a reader 77, a camera 78, and a system transmission line 79. The system transmission line 79 includes an address bus, a data bus, and a control signal line. In the mobile terminal 70, the processor 71, the main memory 72, the auxiliary storage device 73, the wireless unit 74, the touch panel 75, the scanner 76, the reader 77, and the camera 78 are connected to the system transmission line 79. In the mobile terminal 70, a computer is configured by the processor 71, the main memory 72, and the auxiliary storage device 73 and the system transmission line 79 that connects the foregoing.

The processor 71 is equivalent to a central part of the computer. The processor 71 controls the units in order to realize various functions of the mobile terminal 70 according to an operating system or application programs. The processor 71 may be, for example, a CPU (Central Processing Unit).

The main memory 72 is equivalent to a main storage part of the computer. The main memory 72 includes a nonvolatile memory region and a volatile memory region. The main memory 72 stores the operating system or the application programs in the nonvolatile memory region. The main memory 72 sometimes stores, in the nonvolatile or volatile memory region, data necessary for the processor 71 in executing processing for controlling the units. The main memory 72 uses the volatile memory region as a work area where data is rewritten as appropriate by the processor 71. The nonvolatile memory region is, for example, a ROM (Read Only Memory). The volatile memory region is, for example, a RAM (Random Access Memory).

The auxiliary storage device 73 is equivalent to an auxiliary storage part of the computer. For example, an EEPROM (Electric Erasable Programmable Read-Only Memory), an HDD (Hard Disc Drive), or an SSD (Solid State Drive) could be the auxiliary storage device 73. The auxiliary storage device 73 saves data used by the processor 71 in performing various kinds of processing and data generated by the processing in the processor 71. The auxiliary storage device 73 sometimes stores the application programs.

The application programs stored in the main memory 72 or the auxiliary storage device 73 include a control program described concerning information processing executed in the mobile terminal 70. A method of installing the control program in the main memory 72 or the auxiliary storage device 73 is not particularly limited. The control program can be installed in the main memory 72 or the auxiliary storage device 73 by recording the control program in a removable recording medium or distributing the control program with communication via a network. A form of the recording medium may be any form if the recording medium can store a program like a CD-ROM, a memory card, or the like and can be read by a device.

The wireless unit 74 performs wireless communication of data according to a wireless communication protocol between the wireless unit 74 and the access point 80.

The touch panel 75 is a device functioning as both an input device and a display device of the mobile terminal 70. The touch panel 75 detects a touch position on a displayed image and outputs information concerning the touch position to the processor 71.

The scanner 76 reads a code symbol such as a barcode or a two-dimensional data code attached to a commodity. A code symbol representing a commodity code of the commodity is attached to the commodity. The scanner 76 outputs data of the read code symbol to the processor 71. The scanner 76 may be a type for reading a code symbol with scanning of a laser beam or a type for reading a code symbol from an image captured by an imaging device, for example.

The reader 77 reads data recorded in a recording medium and outputs the read data to the processor 71. The reader 77 is a magnetic card reader if the recording medium is a magnetic card. The reader 77 is an IC card reader if the recording medium is a contact IC card. In the case of a recording medium using RFID (Radio Frequency Identification) such as a noncontact IC card or a smartphone, an RFID reader is used as the reader 77.

The camera 78 is provided in the cart C to be able to photograph, from above, a basket placed on a basket receiving section of the cart C. The camera 78 is a camera for monitoring whether the user, who is the user of the cart C, correctly puts a purchased commodity in the basket.

In the mobile terminal 70 including the circuit components explained above, the processor 71, the main memory 72, the auxiliary storage device 73, the wireless unit 74, and the touch panel 75 may be configured by a tablet terminal TM. The scanner 76, the reader 77 and the camera 78 are electrically connected to the tablet terminal TM to configure the mobile terminal 70.

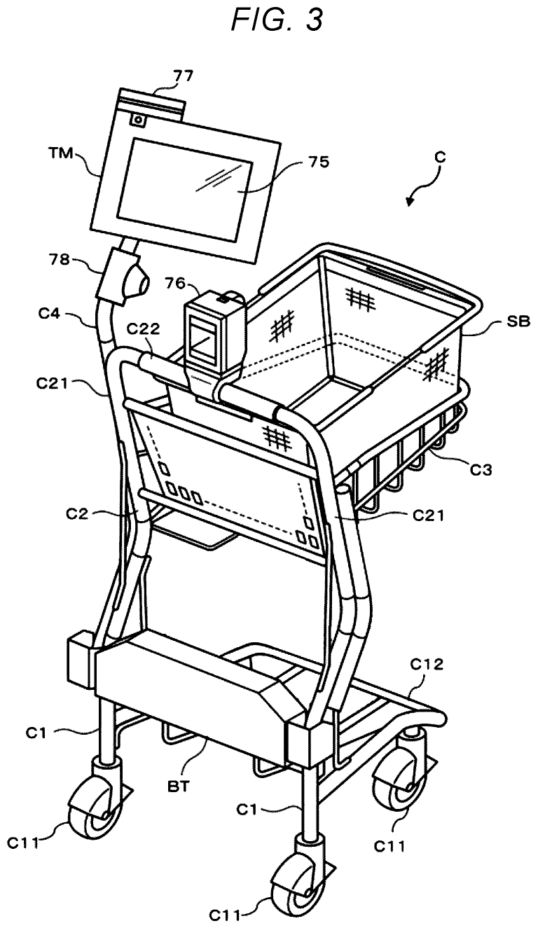

FIG. 3 is a perspective view illustrating an example of the cart C in which the mobile terminal 70 is provided. The cart C includes a caster section C1 for movement, a handle frame section C2, and a basket receiving section C3. The caster section C1 includes four wheels C11 for smoothly moving the cart C on a floor surface. The caster section C1 includes a receiving section C12 for placing a large baggage that cannot be put in a shopping basket SB. The handle frame section C2 includes a pair of vertical frames C21, C21 erected on a rear wheel side of the caster section C1 and a handlebar C22 that couples the upper ends of the vertical frames C21, C21. The basket receiving section C3 is present in a forward direction from a halfway part of the handle frame section C2. In the cart C, the shopping basket SB equipped in the store can be placed on the basket receiving section C3. The shopping basket SB is a basket for storing commodities.

The scanner 76 is present in a halfway part of the handlebar C22. The scanner 76 is attached to the handlebar C22 such that a reading window is located on a near side. The near side is a side where the user, holding the handlebar C22 and pushing the cart C, stands.

A pole C4 is attached to one vertical frame C21. The distal end of the pole C4 is located above the handlebar C22. The tablet terminal TM is attached to the distal end portion of the pole C4 with a screen of the touch panel 75 facing forward. The reader 77 is attached to the tablet terminal TM such that a card slit is located on the near side. In FIG. 3, the reader 77 is a magnetic card reader. The camera 78 is attached to a halfway part of the pole C4 to image, from above, the entire shopping basket SB placed on the basket receiving section C3.

A battery BT is attached between the vertical frames C21, C21 on the lower end side of the handle frame section C2. The battery BT is a driving power supply for the tablet terminal TM, the scanner 76, the reader 77, and the camera 78.

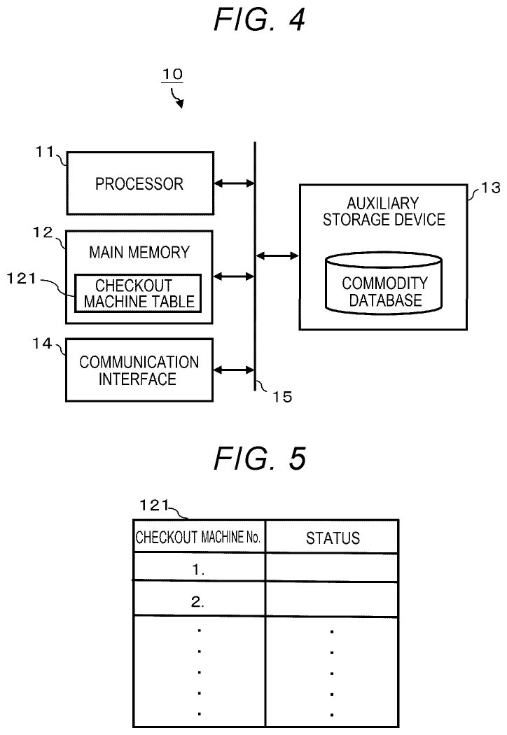

FIG. 4 is a block diagram illustrating a main part circuit configuration of the store server 10. The store server 10 includes a processor 11, a main memory 12, an auxiliary storage device 13, a communication interface 14, and a system transmission line 15. The system transmission line 15 includes an address bus, a data bus, and a control signa line. In the store server 10, the processor 11, the main memory 12, the auxiliary storage device 13, and the communication interface 14 are connected to the system transmission line 15. In the store server 10, a computer is configured by the processor 11, the main memory 12, and the auxiliary storage device 13 and the system transmission line 15 that connects the foregoing.

The processor 11 is equivalent to a central part of the computer. The processor 11 controls the units in order to realize various functions of the store server 10 according to an operating system or application programs. The processor 11 is, for example, a CPU.

The main memory 12 is equivalent to a main storage part of the computer. The main memory 12 includes a nonvolatile memory region and a volatile memory region. The main memory 12 stores the operating system or the application programs in the nonvolatile memory region. The main memory 12 sometimes stores, in the nonvolatile or volatile memory region, data necessary for the processor 11 in executing processing for controlling the units. The main memory 12 uses the volatile memory region as a work area where data is rewritten as appropriate by the processor 11. The nonvolatile memory region is, for example, a ROM. The volatile memory region is, for example, a RAM.

The auxiliary storage device 13 is equivalent to an auxiliary storage part of the computer. For example, an EEPROM, an HDD, or an SSD could be the auxiliary storage device 13. The auxiliary storage device 13 saves data used by the processor 11 in performing various kinds of processing, data created by the processing in the processor 11, or the like. The auxiliary storage device 13 sometimes stores the application programs.

The communication interface 14 is connected to the network 2. The communication interface 14 performs data communication according to a communication protocol between the communication interface 14 and other devices connected via the network 2.

The store server 10 having such a configuration uses a part of the volatile memory region of the main memory 12 as a checkout machine table 121.

FIG. 5 is a schematic diagram illustrating an example of the checkout machine table 121. As illustrated in FIG. 5, the checkout machine table 121 is a table in which statuses of the checkout machines 60 are described in the order of a series of checkout machine numbers. The statuses are information indicating states of the checkout machines 60 identified by the checkout machine numbers corresponding to the statuses. The states of the checkout machines 60 include “idling” and “paying”. The “idling” is a state from when checkout for the previous user is ended until when checkout for the next user is started. The “paying” is a state from when checkout for one user is started until when the checkout is ended. The states of the checkout machines 60 are not limited to the “idling” and the “paying”.

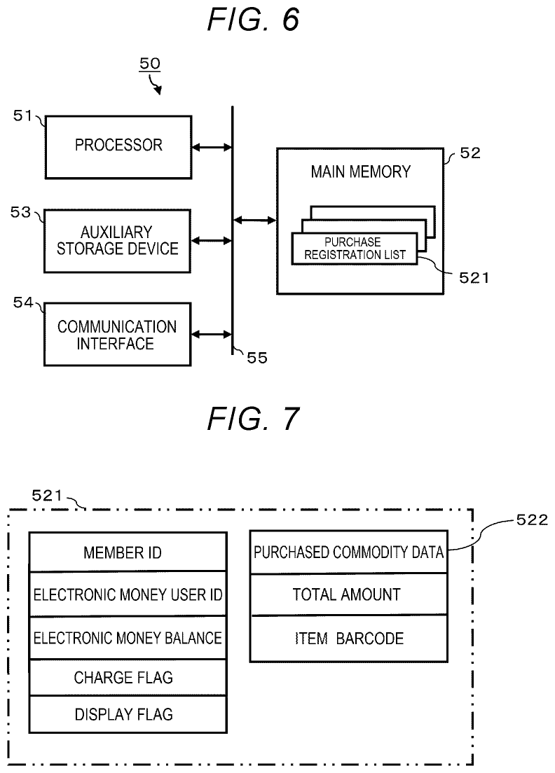

FIG. 6 is a block diagram illustrating a main part circuit configuration of the virtual POS server 50. The virtual POS server 50 may include a processor 51, a main memory 52, an auxiliary storage device 53, a communication interface 54, and a system transmission line 55. The system transmission line 55 may include an address bus, a data bus, and a control signal line. In the virtual POS server 50, the processor 51, the main memory 52, the auxiliary storage device 53, and the communication interface 54 are connected to the system transmission line 55. In the virtual POS server 50, a computer is configured by the processor 51, the main memory 52, and the auxiliary storage device 53 and the system transmission line 55 that connects the foregoing.

The processor 51 is equivalent to a central part of the computer. The processor 51 controls the units in order to realize various functions of the virtual POS server 50 according to an operating system or application programs. The processor 51 may be, for example, a CPU.

The main memory 52 is equivalent to a main storage part of the computer. The main memory 52 includes a nonvolatile memory region and a volatile memory region. The main memory 52 stores the operating system or the application programs in the nonvolatile memory region. The main memory 52 sometimes stores, in the nonvolatile or volatile memory region, data necessary for the processor 51 in executing processing for controlling the units. The main memory 52 uses the volatile memory region as a work area where data is rewritten as appropriate by the processor 51. The nonvolatile memory region is, for example, a ROM. The volatile memory region is, for example, a RAM.

The auxiliary storage device 53 is equivalent to an auxiliary storage part of the computer. For example, an EEPROM, an HDD, or an SSD could be the auxiliary storage device 53. The auxiliary storage device 53 saves data used by the processor 51 in performing various kinds of processing or data generated by the processing in the processor 51. The auxiliary storage device 53 sometimes stores the application programs.

The communication interface 54 is connected to the network 2. The communication interface 54 performs data communication according to a communication protocol between the communication interface 54 and other devices connected via the network 2.

The virtual POS server 50 having such a configuration uses a part of the volatile memory region of the main memory 52 as a creation region for a purchase registration list 521. The virtual POS server 50 can create a plurality of purchase registration lists 521 in this region.

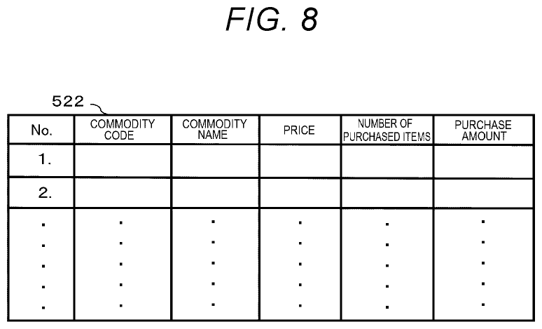

FIG. 7 is a schematic diagram illustrating an example of the purchase registration list 521. As illustrated in FIG. 7, the purchase registration list 521 includes regions for respectively storing a member ID, an electronic money user ID, an electronic money balance, a charge flag, a display flag, purchased commodity data 522 (see FIG. 8), a total amount, and a checkout barcode. The charge flag, the display flag, and the checkout barcode are explained below. The total amount is a total of purchase amounts included in the purchased commodity data 522. The purchase registration list 521 is correlated with the member ID of the mobile terminal 70 and created.

FIG. 8 is a schematic diagram illustrating an example of the purchased commodity data 522. As illustrate in FIG. 8, the purchased commodity data 522 includes, in the order of a series of numbers, a commodity code, a commodity name, a price, the number of purchased items, and a purchase amount of a purchased commodity purchased by the user. The number of purchased items is the number of purchased items of a commodity identified by the commodity code. The purchase amount is an amount obtained by multiplying together the price and the number of purchased items.

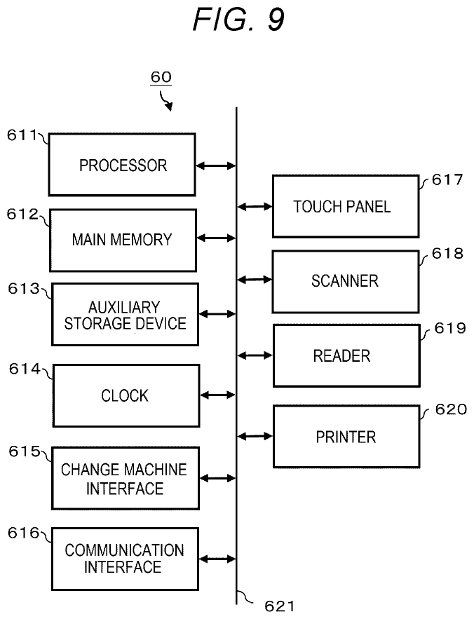

FIG. 9 is a block diagram illustrating a main part circuit configuration of the checkout machine 60. The checkout machine 60 may include a processor 611, a main memory 612, an auxiliary storage device 613, a clock 614, a change machine interface 615, a communication interface 616, a touch panel 617, a scanner 618, a reader 619, a printer 620, and a system transmission line 621. The system transmission line 621 includes an address bus, a data bus, and a control signal line. The system transmission line 621 connects the processor 611, the main memory 612, the auxiliary storage device 613, the clock 614, the change machine interface 615, the communication interface 616, the touch panel 617, the scanner 618, the reader 619, and the printer 620 to one another. The processor 611, the main memory 612, and the auxiliary storage device 613 are connected by the system transmission line 621 to configure a computer of the checkout machine 60.

The processor 611 is equivalent to a central part of the computer. The processor 611 controls the units in order to realize various functions of the checkout machine 60 according to an operating system or application programs. The processor 611 is, for example, a CPU.

The main memory 612 is equivalent to a main storage part of the computer. The main memory 612 includes a nonvolatile memory region and a volatile memory region. The main memory 612 stores the operating system or the application programs in the nonvolatile memory region. The main memory 612 sometimes stores, in the nonvolatile or volatile memory region, data necessary for the processor 611 in executing processing for controlling the units. The main memory 612 uses the volatile memory region as a work area where data is rewritten as appropriate by the processor 611. The nonvolatile memory region is, for example, a ROM. The volatile memory region is, for example, a RAM.

The auxiliary storage device 613 is equivalent to an auxiliary storage part of the computer. For example, an EEPROM, an HDD, or an SSD could be the auxiliary storage device 613. The auxiliary storage device 613 saves data used by the processor 611 in performing various kinds of processing, data created by the processing in the processor 611, or the like. The auxiliary storage device 613 sometimes stores the application programs.

The application programs stored in the main memory 612 or the auxiliary storage device 613 include a control program described concerning information processing executed in the checkout machine 60. A method of installing the control program in the main memory 612 or the auxiliary storage device 613 is not particularly limited. The control program can be installed in the main memory 612 or the auxiliary storage device 613 by recording the control program in a removable recording medium or distributing the control program with communication via a network. A form of the recording medium may be any form if the recording medium can store a program like a CD-ROM, a memory card, or the like and can be read by a device.

The clock 614 functions as a time information source of the checkout machine 60. The processor 611 tracks present date and time based on time information tracked by the clock 614.

The change machine interface 615 performs data communication between the change machine interface 615 and an automatic change machine. The change machine interface 615 receives data of a deposit amount, data of the number of stored money, and the like from the automatic change machine. The change machine interface 615 transmits change data to the automatic change machine.

The communication interface 616 is connected to the network 2. The communication interface 616 performs data communication according to a communication protocol between the communication interface 616 and other devices connected via the network 2.

The touch panel 617 is a device functioning as both of an input device and a display device of the checkout machine 60. The touch panel 617 detects a touch position on a displayed image and outputs information concerning the touch position to the processor 611.

The scanner 618 is an example of a reading device that reads a code symbol such as a barcode or a two-dimensional code. The scanner 618 may be a type for reading a code symbol with scanning of a laser beam or a type for reading a code symbol from an image captured by an imaging device.

The reader 619 reads data recorded in a recording medium and outputs the read data to the processor 611. The reader 619 is a magnetic card reader if the recording medium is a magnetic card. The reader 619 is an IC card reader if the recording medium is a contact IC card. In the case of a recording medium using RFID (Radio Frequency Identification) such as a noncontact IC card or a smartphone, an RFID reader is used as the reader 619.

The printer 620 prints various character strings, images, or the like on a receipt to thereby dispense a receipt. As the printer 620 of this type, for example, a thermal printer or a dot-impact printer can be used. The printer 620 functions as a printing device of the checkout machine 60.

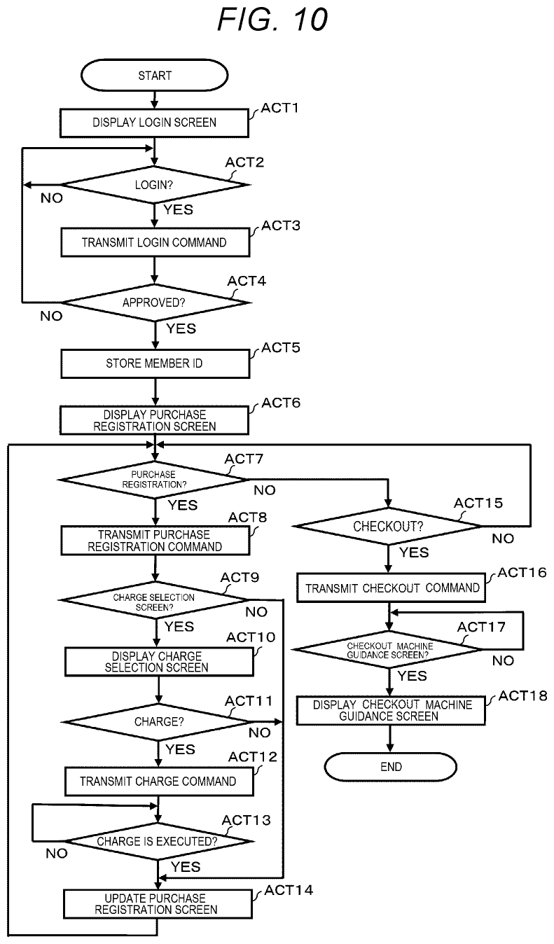

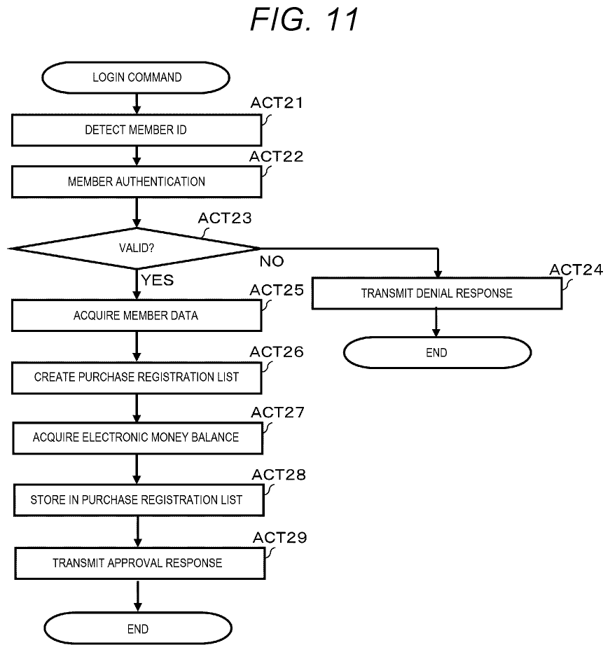

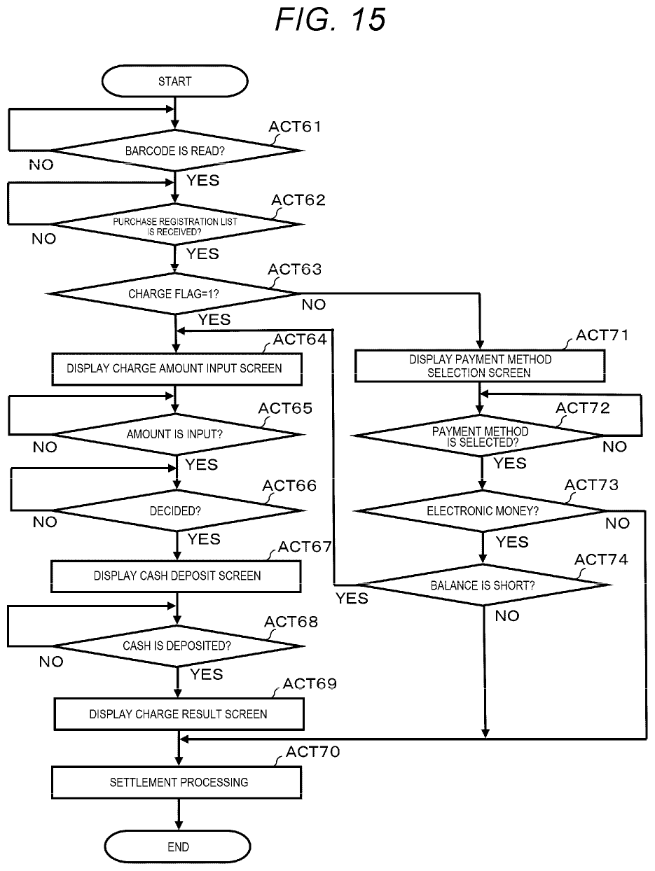

FIG. 10 is a flowchart illustrating a main part control procedure of the processor 71 in the mobile terminal 70. FIGS. 11 to 14 are flowcharts illustrating main part control procedures of the processor 51 in the virtual POS server 50. FIG. 15 is a flowchart illustrating a main part control procedure of the processor 611 in the checkout machine 60.

A main operation of the store system 1 in which the user, who is a member, performs registration to settlement of a purchased commodity by himself or herself using the mobile terminal 70 of the cart C is explained below. The operation explained below is an example. A procedure of the operation is not particularly limited if the same result is obtained.

First, the user performing shopping using the cart C touches the touch panel 75. If the touch panel 75 is touched, the processor 71 in an idle state starts. The processor 71 starts information processing of the procedure illustrated in the flowchart of FIG. 10.

In ACT 1, the processor 71 causes the touch panel 75 to display a login screen. The login screen is a screen for instructing the member to perform login operation. The user, who is a member, owns a member card in which a member code of the user is recorded. The user, who confirms the login screen, causes the reader 77 to read data of the member card. If the data of the member card is read by the reader 77, the data of the member card is given to the processor 71.

In ACT 2, the processor 71, which causes the touch panel 75 to display the login screen, waits for login. The processor 71 receives data from the reader 77 and, if confirming that the data is the data of the member card including the member ID, determines that the login is performed. That is, the processor 71 determines YES in ACT 2 and proceeds to ACT 3.

In ACT 3, the processor 71 controls the wireless unit 74 to transmit a login command to the virtual POS server 50. According to the control, the wireless unit 74 wirelessly transmits the login command. The login command is received by the access point 80 and transmitted to the virtual POS server 50 through the network 2. The login command includes the member ID of the member card read by the reader 77.

If receiving a command from the mobile terminal 70 via the communication interface 54, the processor 51 of the virtual POS server 50 confirms a type of the command. If the received command is the login command, the processor 51 starts command reception processing of the procedure illustrated in the flowchart of FIG. 11.

In ACT 21, the processor 51 detects the member ID from the login command. In ACT 22, the processor 51 performs authentication of the member identified by the member ID. Specifically, the processor 51 inquires of the member server 20 whether a member data record including the member ID is present in the member database. As a result, if receiving, from the member server 20, a response that the relevant member data record is present in the member database, the processor 51 recognizes that member authentication is valid. On the other hand, if receiving, from the member server 20, a response that the relevant member data record is absent in the member database, the processor 51 recognizes that the member authentication is invalid.

In ACT 23, the processor 51 confirms the result of the member authentication. If the authentication result is invalid, the processor 51 determines NO in ACT 23 and proceeds to ACT 24. In ACT 24, the processor 51 controls the communication interface 54 to transmit a denial response command to the mobile terminal 70. According to this control, the communication interface 54 transmits the denial response command. The denial response command is wirelessly transmitted from the access point 80 via the network 2 and received by the mobile terminal 70 at a login command transmission source.

If the authentication result is valid, the processor 51 determines YES in ACT 23 and proceeds to ACT 25. In ACT 25, the processor 51 requests the member server 20 to transmit member data of the member identified by the member ID and acquires the member data including the member ID from the member server 20.

In ACT 26, the processor 51 creates the purchase registration list 521 in the main memory 52. The processor 51 writes the member ID included in the login command in the purchase registration list 521.

In ACT 27, the processor 51 inquires of the electronic money management server 30 about an electronic money balance using the electronic money user ID included in the acquired member data. According to this inquiry, the electronic money management server 30 reads out an electronic money balance correlated with the electronic money user ID and responds to the virtual POS server 50. In this way, the processor 51 acquires the electronic money balance.

In ACT 28, the processor 51 stores the electronic money balance in the purchase registration list 521. If finishing storing the balance, in ACT 29, the processor 51 controls the communication interface 54 to transmit an approval response command to the mobile terminal 70. According to this control, the communication interface 54 transmits the approval response command. The approval response command is wirelessly transmitted from the access point 80 via the network 2 and received by the mobile terminal 70 at the login command transmission source.

In this way, in ACT 24 or ACT 29, the virtual POS server 50, which receives the login command, transmits the denial or approval response command to the mobile terminal 70 at the login command transmission source. If finishing transmitting the response command, the processor 51 ends login command reception processing.

Referring back to FIG. 10, in ACT 4, the processor 71 of the mobile terminal 70, which controls the transmission of the login command in ACT 3, waits for the response command from the virtual POS server 50. If receiving the denial response command from the virtual POS server 50, the processor 71 determines NO in ACT 4 and returns to ACT 2. Therefore, the user performs login again.

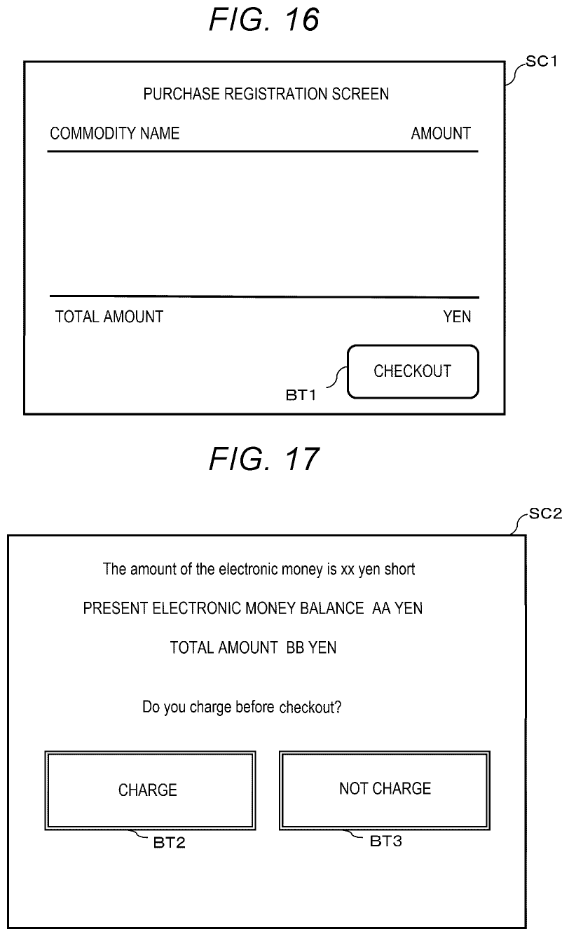

If receiving the approval response command from the virtual POS server 50, the processor 71 determines YES in ACT 4 and proceeds to ACT 5. In ACT 5, the processor 71 stores the member ID included in the approval response command in the main memory 72. In ACT 6, the processor 71 causes the touch panel 75 to display a purchase registration screen SC1 (see FIG. 16).

FIG. 16 is a schematic diagram illustrating an example of the purchase registration screen SC1. As illustrated in FIG. 16, regions for displaying a commodity name and a purchase amount of a commodity, purchase registration for which is performed, and a total amount are formed in the purchase registration screen SC1. An image of checkout button BT1 for instructing checkout is displayed on the purchase registration screen SC1.

The user, who confirms the purchase registration screen SC1, walks around the selling floor and stores a purchased commodity in the cart C. For example, the user puts the purchased commodity in the shopping basket SB placed on the basket receiving section C3. Before putting the purchased commodity in the shopping basket SB, the user operates the scanner 76 to read a code symbol attached to the commodity. If the code symbol is read by the scanner 76, a commodity code represented by the code symbol is input to the mobile terminal 70. That is, the commodity identified by the commodity code is registered.

A code symbol is sometimes not attached to a part of commodities such as perishables. Although not illustrated, if a code symbol is not attached to a purchased commodity, the user touches a commodity button corresponding to the purchased commodity out of commodity buttons displayed on the screen of the touch panel 75. If the commodity button is touched, a commodity code of the commodity corresponding to the commodity button is input to the mobile terminal 70. That is, the commodity identified by the commodity code is registered. As another means, for example, a code symbol such as a barcode or a two-dimensional code may be provided near a price tag disposed around a commodity such as vegetable and fruit. The scanner 76 may read the code symbol.

Referring back to FIG. 10, if ending the processing in ACT 5 and ACT 6, in ACT 7, the processor 71 confirms whether purchase registration is performed. If confirming that the purchase registration is performed, the processor 71 determines YES in ACT 7 and proceeds to ACT 8. In ACT 8, the processor controls the wireless unit 74 to transmit a purchase registration command to the virtual POS server 50. According to this control, the wireless unit 74 wirelessly transmits the purchase registration command. The purchase registration command is received by the access point 80 and transmitted to the virtual POS server 50 via the network 2. The purchase registration command includes the member ID stored in the main memory 72 and the commodity code of the registered commodity.

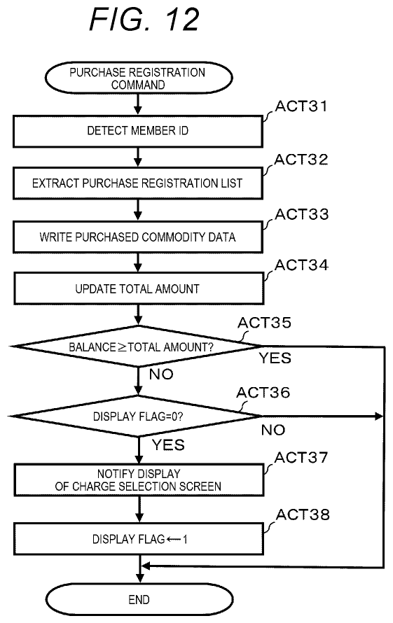

The processor 51 of the virtual POS server 50, which receives the purchase registration command, starts command reception processing of the procedure illustrated in the flowchart of FIG. 12.

In ACT 31, the processor 51 detects the member ID from the purchase registration command. In ACT 32, the processor 51 extracts the purchase registration list 521 in which the member ID is described.

If ending the processing in ACT 31 and ACT 32, in ACT 33, the processor 51 creates the purchased commodity data 522 based on the commodity code included in the purchase registration command and writes the purchased commodity data 522 in the purchase registration list 521. In ACT 34, the processor 51 updates the total amount of the purchase registration list 521 to an amount obtained by adding a purchase amount of the purchased commodity data 522 written again to the total amount.

In ACT 35, the processor 51 confirms whether the total amount after the update exceeds the electronic money balance. If the total amount does not exceed the electronic money balance, the processor 51 determines YES in ACT 35 and ends purchase registration command reception processing.

If the total amount exceeds the electronic money balance, the processor 51 determines NO in ACT 35 and proceeds to ACT 36. In ACT 36, the processor 51 confirms whether the display flag is “0”. The display flag is one-bit data that is “0” in an initial state until a charge selection screen SC2 (see FIG. 17) is displayed on the mobile terminal 70 and is set to “1” if the charge selection screen SC2 is displayed.

If the charge selection screen SC2 is already displayed, the processor 51 determines NO in ACT 36 and ends the purchase registration command reception processing. At this point in time, however, since the charge selection screen SC2 is not displayed on the mobile terminal 70 yet, the display flag is “0” in the initial state. Therefore, in ACT 36, the processor 51 determines YES and proceeds to ACT 37.

In ACT 37, the processor 51 controls the communication interface 54 to display the charge selection screen SC2 on the mobile terminal 70. According to this control, the communication interface 54 transmits a display command for notifying the display of the charge selection screen SC2. The display command is wirelessly transmitted from the access point 80 via the network 2 and received by the mobile terminal 70 at a purchase registration command transmission source. In the mobile terminal 70 that receives the display command, the charge selection screen SC2 is displayed on the touch panel 75.

FIG. 17 is a schematic diagram illustrating an example of the charge selection screen SC2. As illustrated in FIG. 17, on the charge selection screen SC2, a message for notifying that the electronic money balance is short, the present electronic money balance, a total amount of a commodity, purchase registration for which is performed, and a message for inquiring whether charging is performed before checkout are displayed. On the charge selection screen SC2, images of a “charge” button BT2 and a “not charge” button BT3 are displayed.

A user charging the electronic money before checkout touches the “charge” button BT2. A user not charging the electronic money touches the “not charge” button BT3.

Referring back to FIG. 12, since the charge selection screen SC2 is displayed on the mobile terminal 70, in ACT 38, the processor 51 of the virtual POS server 50 updates the display flag to “1”. The processor 51 ends the purchase registration command reception processing.

Referring back to FIG. 10, in ACT 9, the processor 71 of the mobile terminal 70, which controls the transmission of the purchase registration command in ACT 8, confirms whether the processor 71 receives a display command for the charge selection screen SC2 from the virtual POS server 50. If not receiving the display command, that is, if the total amount does not exceed the electronic money balance, the processor 71 determines NO in ACT 9 and proceeds to ACT 14.

If receiving the display command for the charge selection screen SC2 from the virtual POS server 50, the processor 71 determines YES in ACT 9 and proceeds to ACT 10. In ACT 10, the processor 71 causes the touch panel 75 to display the charge selection screen SC2.

In ACT 11, the processor 71 confirms whether the “charge” button BT2 is touched. If the “charge” button BT2 is not touched and the “not charge” button BT3 is touched, the processor 71 determines NO in ACT 11 and proceeds to ACT 14.

If the “charge” button BT2 is touched, the processor 71 determines YES in ACT 11 and proceeds to ACT 12.

In ACT 12, the processor 71 may control the wireless unit 74 to transmit a charge command to the virtual POS server 50. According to this control, the wireless unit 74 wirelessly transmits the charge command. The charge command is received by the access point 80 and transmitted to the virtual POS server 50 through the network 2. The charge command includes the member ID of the member card read by the reader 77.

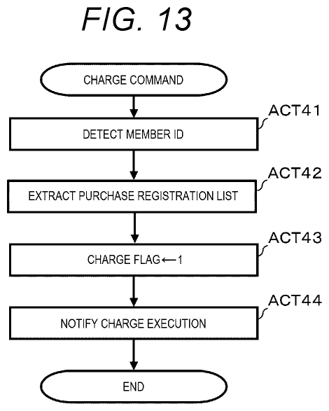

If receiving a command from the mobile terminal 70 via the communication interface 54, the processor 51 of the virtual POS server 50 confirms a type of the command. If the received command is the charge command, the processor 51 starts command reception processing of the procedure illustrated in the flowchart of FIG. 13.

In ACT 41, the processor 51 detects the member ID from the charge command. In ACT 42, the processor 51 extracts the purchase registration list 521 in which the member ID is described.

If ending the processing in ACT 41 and ACT 42, in ACT 43, the processor 51 updates the charge flag correlated with the member ID detected from the charge command and stored in the purchase registration list 521 to “1”. The charge flag is one-bit data for identifying whether the “charge” button BT2 is touched on the charge selection screen SC2. That is, the charge flag is charge instruction information. In at least one embodiment, the charge flag is “1” if the “charge” button BT2 is touched and the charge flag is “0” if the “charge” button BT2 is not touched, that is, if the “not charge” button BT3 is touched. At this point in time, since the “charge” button BT2 is touched, the charge flag is “1”.

In ACT 44, the processor 51 controls the communication interface 54 to transmit a charge execution command to the mobile terminal 70. According to this control, the communication interface 54 transmits the charge execution command. The charge execution command is wirelessly transmitted from the access point 80 via the network 2 and received by the mobile terminal at a charge command transmission source. The charge execution command includes the member ID detected from the charge command. The processor 51, which performs charge execution, ends charge command reception processing.

Referring back to FIG. 10, in ACT 13, the processor 71 of the mobile terminal 70, which controls the transmission of the charge command in ACT 12, waits for the charge execution command from the virtual POS server 50. If receiving the charge execution command from the virtual POS server 50, the processor 71 determines YES in ACT 13 and proceeds to ACT 14. In ACT 14, the processor 71 updates the purchase registration screen SC1. Although not illustrated, a message such as “Please charge the electronic money before checkout” is displayed on the purchase registration screen SC1 after the update. If the processor 71 determines NO in ACT 9 or ACT 11 and proceeds to ACT 14, a message for urging charging of the electronic money before checkout is not displayed on the purchase registration screen SC1. The processor 71, which updates the purchase registration screen SC1, returns to ACT 7. If confirming the purchase registration is performed in the waiting state in ACT 7, the processor 71 executes the processing in ACT 8 to ACT 14 in the same manner as explained above. Therefore, in the virtual POS server 50, the processor 51 executes the purchase registration command reception processing illustrated in FIG. 12 and the charge command reception processing illustrated in FIG. 13 again.

If the purchase registration is not performed, the processor 71 determines NO in ACT 7 and proceeds to ACT 15. In ACT 15, the processor 71 confirms whether payment is instructed.

An image of the checkout button BT1 is displayed on a part of the purchase registration screen SC1. The user finishing the purchase touches the checkout button BT1. If the checkout button BT1 is touched, the processor 71 recognizes that checkout is instructed. If accounting is not instructed, the processor 71 determines NO in ACT 15 and returns to ACT 7.

If confirming that checkout is instructed, the processor 71 determines YES in ACT 15 and proceeds to ACT 16. In ACT 16, the processor 71 controls the wireless unit 74 to transmit a checkout command to the virtual POS server 50. According to this control, the wireless unit 74 wirelessly transmits the checkout command. The checkout command is received by the access point 80 and transmitted to the virtual POS server 50 via the network 2. The checkout command includes the member ID stored in the main memory 72.

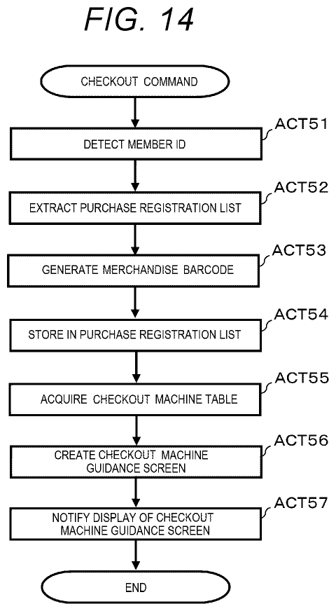

The processor 51 of the virtual POS server 50, which receives the checkout command, starts command reception processing of the procedure illustrated in the flowchart of FIG. 14.

In ACT 51, the processor 51 detects the member ID from the checkout command. In ACT 52, the processor 51 extracts the purchase registration list 521 in which the member ID is described.

If ending the processing in ACT 51 and ACT 52, in ACT 53, the processor 51 generates data of a checkout barcode. The checkout barcode is a barcode for identifying a user who makes payment in the checkout machine 60. The checkout barcode is generated for each of users who make payment in the checkout machine 60. In ACT 54, the processor 51 stores the checkout barcode in the purchase registration list 521.

In ACT 55, the processor 51 inquires of the checkout machine table 121 of the store server 10. According to this inquiry, the store server 10 reads out the checkout machine table 121 and responds to the virtual POS server 50. In this way, the processor 51 acquires the checkout machine table 121.

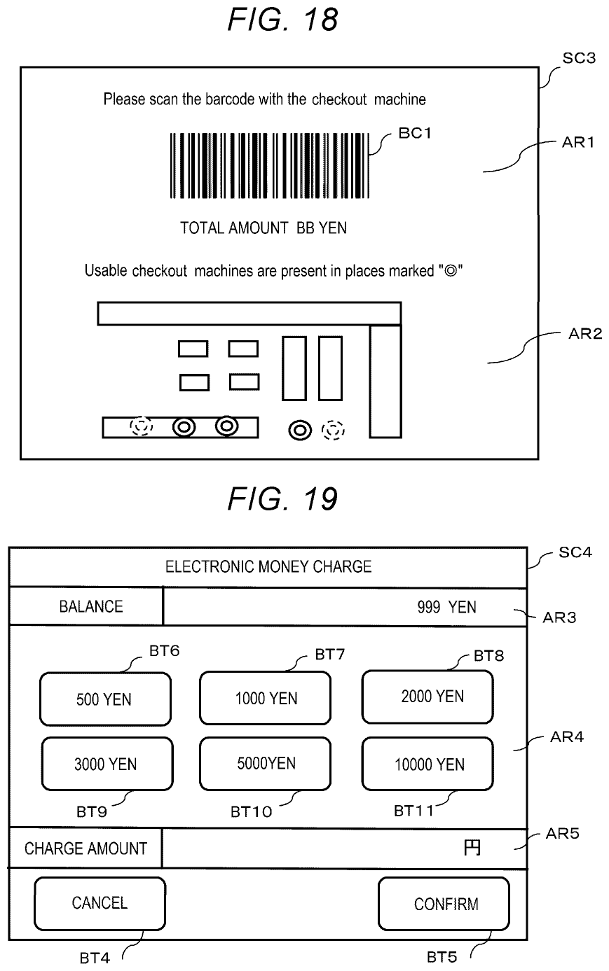

In ACT 56, the processor 51 creates a checkout machine guidance screen SC3 (see FIG. 18) based on data of the acquired checkout machine table 121. The checkout machine guidance screen SC3 also includes the checkout barcode generated in ACT 53. In ACT 57, the processor 51 controls the communication interface 54 to perform display of the checkout machine guidance screen SC3 in the mobile terminal 70. According to this control, the communication interface 54 transmits a screen command for notifying the display of the checkout machine guidance screen SC3. The screen command is wirelessly transmitted from the access point 80 via the network 2 and received by the mobile terminal 70 at a checkout command transmission source. The processor 51, which notifies the display of the checkout machine guidance screen SC3, ends checkout command reception processing.

Referring back to FIG. 10, in ACT 17, the processor 71 of the mobile terminal 70, which controls the transmission of the checkout command in ACT 16, waits for the screen command from the virtual POS server 50. If receiving the screen command from the virtual POS server 50, in ACT 17, the processor 71 determines YES and proceeds to ACT 18. In ACT 18, the processor 71 causes the touch panel 75 to display the checkout machine guidance screen SC3.

FIG. 18 is a schematic diagram illustrating an example of the checkout machine guidance screen SC3. As illustrated in FIG. 18, a display area AR1 for a checkout barcode and a display area AR2 for a checkout machine guidance image may be formed on the checkout machine guidance screen SC3. In the display area AR1, a checkout barcode BC1, a total amount of a commodity, purchase registration for which is performed, and a message for urging the user to scan the checkout barcode with the checkout machine 60 are displayed. In the display area AR2, an in-store map is displayed together with a message indicating setting places of usable checkout machines 60. The in-store map is created based on the checkout machine table 121. Setting places of the checkout machines 60, a status of which in the checkout machine table 121 is “idling”, that is, the checkout machines 60 usable by the user at this point in time, are indicated by solid line double circles. Setting places of the checkout machines 60, a status of which in the checkout machine table 121 is “paying”, that is, the checkout machines 60 unusable by the user are indicated by dotted line double circles. The contents of the messages and the in-store map illustrated in FIG. 18 are merely examples. The contents of the message and the in-store map only need notify the checkout barcode to the user and inform the user about usable checkout machines.

Referring back to FIG. 10, the processor 71 of the mobile terminal 70, which displays the checkout machine guidance screen SC3 in ACT 18, ends the information processing procedure.

The user, who confirms the checkout machine guidance screen SC3, moves to a setting place of a usable checkout machine 60 and causes the scanner 618 included in the checkout machine 60 to read the checkout barcode displayed on the checkout machine guidance screen SC3.

In ACT 61 in FIG. 15, the processor 611 of the checkout machine 60 confirms whether the checkout barcode is read. If the checkout barcode is read, the processor 611 determines YES in ACT 61 and proceeds to ACT 62.

The processor 611 inquires of the purchase registration list 521 of the virtual POS server 50 using the read checkout barcode. According to this inquiry, the virtual POS server 50 reads out the purchase registration list 521, in which the inquired checkout barcode is described, and responds to the checkout machine 60. In this way, in ACT 62, the processor 611 confirms whether the processor 611 receives the purchase registration list 521. If receiving the purchase registration list 521, the processor 611 determines YES in ACT 62 and proceeds to ACT 63. In ACT 63, the processor 611 confirms whether the charge flag stored in the received purchase registration list 521 is “1”. If the charge flag is “1”, that is, if the user charges the electronic money, the processor 611 determines YES in ACT 63 and proceeds to ACT 64. In ACT 64, the processor 611 shifts to the charge mode. That is, the processor 611 causes the touch panel 617 included in the checkout machine 60 to display a charge amount input screen SC4 (see FIG. 19) and receives an input of data concerning the charging of the electronic money.

FIG. 19 is a schematic diagram illustrating an example of the charge amount input screen SC4. As illustrated in FIG. 19, a balance display area AR3, an amount button display area AR4, and a charge amount display area AR5 are formed in the charge amount input screen SC4. A cancel button BT4 and a confirm button BT5 are displayed on the charge amount input screen SC4.

An electronic money balance is displayed in the balance display area AR3. In FIG. 19, 999 yen is displayed as the electronic money balance.

A 500 yen button BT6, a 1000 yen button BT7, a 2000 yen button BT8, a 3000 yen button BT9, a 5000 yen button BT10, and a 10000 yen button BT11 are displayed in the amount button display area AR4, for example. The 500 yen button BT6 is a button for inputting a charge amount 500 yen. The 1000 yen button BT7 is a button for inputting a charge amount 1000 yen. The other buttons BT8 to BT11 are similar. The types of buttons displayed in the amount button display area AR4 are not limited to the example illustrated in FIG. 19.

A charge amount input by the amount buttons BT6 to BT11 is displayed in the charge amount display area AR5.

On the charge amount input screen SC4, the user, who touches the amount buttons BT6 to BT11 for the relevant charge amount, subsequently touches the confirm button BT5. If the user stops the charge amount input, the user touches the cancel button BT4.

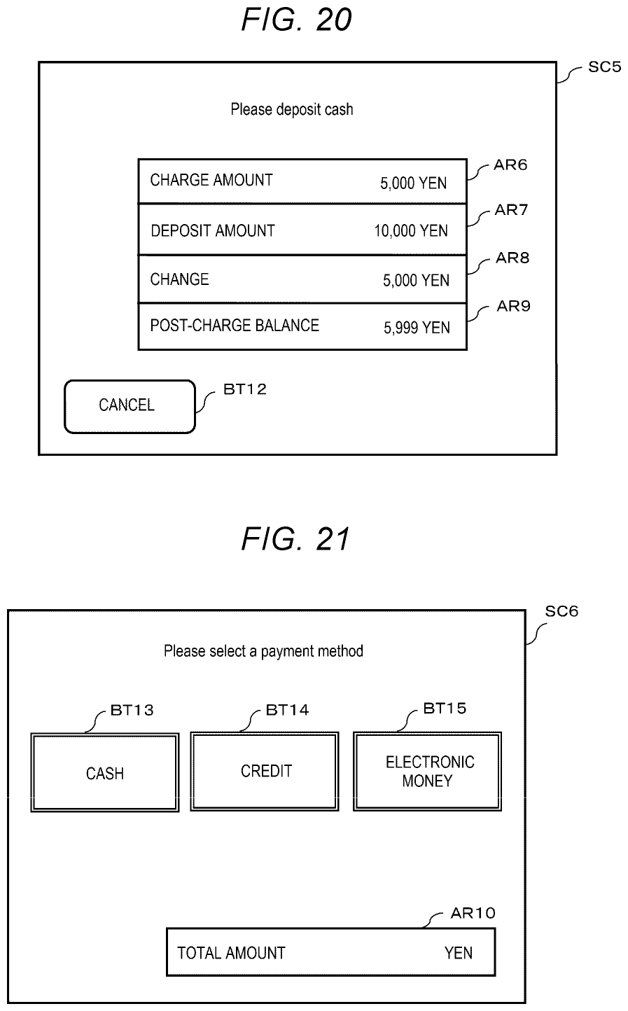

Referring back to FIG. 15, in ACT 65, the processor 611, which causes the touch pane 617 to display the charge amount input screen SC4, waits for the amount buttons BT6 to BT11 to be touched. If the amount buttons BT6 to BT11 are touched, the processor 611 determines YES in ACT 65 and proceeds to ACT 66. In ACT 66, the processor 611 waits for the confirm button BT5 to be touched. If the confirm button BT5 is touched, the processor 611 determines YES in ACT 66 and proceeds to ACT 67. In ACT 67, the processor 611 switches the screen of the touch panel 617 from the charge amount input screen SC4 to a cash deposit screen SC5 (see FIG. 20).

FIG. 20 is a schematic diagram illustrating an example of the cash deposit screen SC5. As illustrated in FIG. 20, a message for urging deposit of cash is displayed on the cash deposit screen SC5. An image of a cancel button BT12, a charge amount area AR6, a deposit amount area AR7, a change area AR8, and a post-charge balance area AR9 are arranged on the cash deposit screen SC5. The deposit amount area AR7 is an area for displaying an amount of cash deposited into the automatic change machine. The change area AR8 is an area for displaying a change amount obtained by the deposit amount and the charge amount. The post-charge balance area AR9 is an area for displaying a balance of the electronic money after the charge amount is charged. In FIG. 20, amounts are displayed in the deposit amount area AR7, the change area AR8, and the post-charge balance area AR9. However, no amount is displayed at a point in time of ACT 67.

Referring back to FIG. 15, in ACT 68, the processor 611 waits for cash to be deposited into the automatic change machine. If cash is deposited, the processor 611 determines YES in ACT 68 and proceeds to ACT 69. In ACT 69, the processor 611 displays a charge result on the cash deposit screen SC5. Specifically, as illustrated in FIG. 20, the processor 611 displays a value of a deposit amount in the deposit amount area AR7, displays a change amount in the change area AR8, and displays a balance after the addition of the value of the deposit amount is displayed in the post-charge balance area AR9.

In ACT 70, the processor 611 executes settlement processing for the electronic money. Since the settlement processing is existing processing and well known, specific explanation of the settlement processing is omitted.

If the charge flag is not “1”, that is, if the user does not charge the electronic money, the processor 611 determines NO in ACT 63 and proceeds to ACT 71. In ACT 71, the processor 611 shifts to the payment mode. That is, the processor 611 causes the touch panel 617 to display a payment method selection screen SC6 (see FIG. 21) and receives an input of data concerning accounting.

FIG. 21 is a schematic diagram illustrating an example of the payment method selection screen SC6. As illustrated in FIG. 21, a message for urging selection of a payment method is displayed on the payment method selection screen SC6. Images of a cash button BT13, a credit button BT14, and an electronic money button BT15 and a total amount area AR10 are arranged on the payment method selection screen SC6.

The cash button BT13 is a button image for receiving a declaration of cash payment. The credit button BT 14 is a button image for receiving a declaration of credit card payment. The electronic money button BT15 is a button image for receiving a declaration of electronic money payment. The total amount area AR10 is an area for displaying a total amount stored in the purchase registration list.

Referring back to FIG. 15, in ACT 72, the processor 611, which controls the display of the payment method selection screen SC6, waits for the payment method to be selected. Specifically, the processor 611 waits for the cash button BT13 to be touched, the credit button BT14 to be touched, or the electronic money button BT15 to be touched.

If the payment method is selected, the processor 611 determines YES in ACT 72 and proceeds to ACT 73.

In ACT 73, the processor 611 confirms whether the electronic money button BT15 is touched. If the electronic money button BT15 is not touched, that is, for example, the cash button BT13 or the credit button BT14 is touched, the processor 611 determines NO in ACT 73 and proceeds to ACT 70. In ACT 70, the processor 611 executes settlement processing by the selected payment method. That is, if the cash button BT13 is touched, the processor 611 executes settlement processing by the cash payment. If the credit button BT14 is touched, the processor 611 executes settlement processing by the credit payment. Since these types of settlement processing are existing processing and well known, specific explanation of the settlement processing is omitted.

If the electronic money button BT15 is touched, the processor 611 determines YES in ACT 73 and proceeds to ACT 74. In ACT 74, the processor 611 confirms whether an electronic money balance is short. If the electronic money balance is not short, the processor 611 determines NO in ACT 74 and proceeds to ACT 70. That is, in ACT 70, the processor 611 executes settlement processing for the electronic money.

If the electronic money balance is short, the processor 611 determines YES in ACT 74 and returns to ACT 64. The processor 611 repeats the following processing in ACT 64 to ACT 70 in the same manner as explained above. The processor 611 ends the information processing of the procedure illustrated in the flowchart of FIG. 15.

As it is evident from the above explanation, the processor 51 executes the processing in ACT 21 to ACT 28 in FIG. 11, whereby the virtual POS server 50, which is an example of an information processing device, configures units including an acquiring unit. That is, the virtual POS server 50 acquires a balance of the electronic money owned by the user identified by the member ID from the electronic money management server 30 via the communication server 40.

The processor 51 executes the processing in ACT 31 to ACT 34 in FIG. 12, whereby the virtual POS server 50 configures additionally a calculating unit. That is, every time a purchased commodity purchased by the user is registered, the virtual POS server 50 adds up purchase amounts of purchased commodities registered up to that point and calculates a price.

Further, the processor 51 executes the processing in ACT 35 to ACT 37 in FIG. 12 and ACT 41 to ACT 44 in FIG. 13, whereby the virtual POS server 50 further configures a storing unit. That is, if a predetermined condition holds between the balance of the electronic money and the price, the virtual POS server 50 correlates charge instruction information of the electronic money with the mobile terminal 70 and stores the charge instruction information.

The processor 611 executes the processing ACT 61 and ACT 62 in FIG. 15, whereby the checkout machine 60 configures units including a receiving unit. That is, the checkout machine 60 receives a payment instruction from the mobile terminal 70.

The processor 611 executes the processing in ACT 63 to ACT 74 in FIG. 15, whereby the checkout machine 60 further configures a mode selecting unit. That is, if receiving a payment instruction from the mobile terminal 70 not correlated with the charge instruction information, the checkout machine 60 selects the payment mode for receiving an input of data concerning payment. If receiving a payment instruction from the mobile terminal 70 correlated with the charge instruction information, the checkout machine 60 selects a charge mode for receiving an input of data concerning charging of the electronic money.

If the checkout machine 60 selects the charge mode and reads a checkout barcode, the screen of the touch panel 617 is switched to the charge amount input screen SC4. The user can charge the electronic money by operating a software key displayed on the screen SC4. Therefore, in the store system 1 including the information processing device and the checkout machine 60, since the processor 611 of the checkout machine 60 does not require the processing in ACT 71 to ACT 74, processing operation steps of the checkout machine 60 can be reduced. As a result, a processing load on the checkout machine 60 is reduced. Since time for charging the electronic money in the checkout machine 60 can be reduced, it is possible to prevent settlement from being delayed.

The setting places of the usable checkout machines 60 are displayed on the checkout barcode and the checkout machine guidance screen SC3. Therefore, the user can efficiently learn the setting places of the usable checkout machines 60 beforehand.

The store system, the information processing device, the checkout machine, and the control program according to at least one embodiment are explained above. However, such an embodiment is not limited to this.

In at least one embodiment, every time a purchased commodity purchased by the user is registered, if a price calculated by adding up purchase amounts of purchased commodities registered to that point exceeds the electronic money balance and the display flag is “0”, the charge selection screen SC2 is displayed. The predetermined condition between the electronic money balance and the price is not limited to this, however. For example, the predetermined condition may be a condition where an amount obtained by subtracting the total amount from the electronic money balance is equal to or less than a set amount or less than the set amount. In this case, a customer may set the set amount in advance.

Incidentally, if the predetermined condition holds if the price exceeds the electronic money balance, it is possible to instruct a customer whose electronic money balance runs short because of shopping to charge the electronic money. Therefore, if the electronic money balance is short, the customer can efficiently perform charging. On the other hand, if it is regarded that the predetermined condition holds if a difference obtained by subtracting the price from the electronic money balance is equal to or less than a set amount or less than the set amount, it is possible to instruct a customer whose electronic money balance decreases to equal to or less than the set amount or less than the set amount because of shopping to charge the electronic money. Therefore, if the electronic money balance is equal to or less than the set amount or less than the set amount, the customer can efficiently perform the charging and increase the balance. Moreover, by enabling the customer to set the set amount by himself or herself, it is possible to determine, for each of customers, a balance at the time when the charging is performed.

In at least one embodiment, the cash payment, the credit payment, and the electronic money payment are illustrated on the payment method selection screen SC6. The payment methods are not limited to these three methods, however.

In at least one embodiment, as an example, the mobile terminal 70 is attached to the cart C. The mobile terminal 70 may not always be attached to the cart C. For example, a smartphone, a tablet terminal, or the like carried by the user may be used as the mobile terminal 70.

In at least one embodiment, the virtual POS server 50 is explained as a form of the information processing device. The virtual POS server 50 is not limited to the virtual POS server 50 explained in at least one embodiment. For example, the virtual POS server 50 may further include the function of at least one of the store server 10, the member server 20, the electronic money management server 30, and the communication server 40 may be the information processing device. In other words, the store server 10, the member server 20, the electronic money management server 30, or the communication server 40 including the function of the virtual POS server 50 may be the information processing device. Accordingly, the functions may be performed by one or more computers.

Several embodiments are explained above. However, the embodiments are presented as merely examples and are not intended to limit the scope of the disclosure. These new embodiments can be implemented in other various forms. Various omissions, substitutions, and changes can be made without departing from the spirit of the disclosure. These embodiments and modifications of the embodiments are included in the scope and the gist of the disclosure and included in the inventions described in claims and the scope of equivalents.

What is claimed is:

1. A store system comprising:
at least one processor, the at least one processor configured to:
acquire a balance of electronic money;
calculate a price when a purchased commodity is registered;
correlate charge instruction information of the electronic money with a mobile terminal and store the charge instruction information when a predetermined condition exists between the balance of the electronic money and the price;
receive a payment instruction from the mobile terminal; and
select, when receiving the payment instruction from the mobile terminal not correlated with the charge instruction information, a payment mode for receiving an input of data concerning payment, and
select, when receiving the payment instruction from the mobile terminal correlated with the charge instruction information, a charge mode for receiving an input relating to charging of the electronic money.

2. The system according to claim 1, wherein the at least one processor is further configured to, when the price exceeds the balance of the electronic money, correlate the charge instruction information of the electronic money with the mobile terminal and store the charge instruction information.

3. The system according to claim 1, wherein the at least one processor is further configured to, when a difference obtained by subtracting the price from the balance of the electronic money is equal to or less than a set amount, correlate the charge instruction information of the electronic money with the mobile terminal and store the charge instruction information.

4. The system according to claim 1, wherein the mobile terminal includes at least one of a smart phone or a tablet.

5. The system according to claim 1, further comprising an information processing device, wherein the information processing device is configured to perform the acquiring, calculating, correlating and storing.

6. The system according to claim 1, further comprising a checkout machine, wherein the checkout machine is configured to perform the selecting.

7. The system according to claim 1, further comprising a checkout machine, wherein the checkout machine includes a display.

8. A checkout machine configuring a store system and an information processing device, the information processing device configured to correlate charge instruction information of electronic money with a mobile terminal and store the charge instruction information when a predetermined condition exists between a balance of the electronic money and a price calculated when a purchased commodity is registered, the checkout machine comprising at least one processor configured to:
receive a payment instruction from the mobile terminal; and
select, when receiving the payment instruction from the mobile terminal not correlated with the charge instruction information, a payment mode for receiving an input of data concerning payment, and
select, when receiving the payment instruction from the mobile terminal correlated with the charge instruction information, a charge mode for receiving an input of data concerning charging of the electronic money.

9. The checkout machine according to claim 8, wherein the mobile terminal comprises at least one of a smart phone or a tablet.

10. The checkout machine according to claim 9, wherein the mobile terminal comprises a display.

11. An information processing device comprising at least one processor configured to:
acquire a balance of electronic money;
calculate a price every time a purchased commodity is registered; and
correlate charge instruction information of the electronic money with a mobile terminal and store the charge instruction information when a predetermined condition holds between the balance of the electronic money and the price.

12. A control method for a checkout machine configuring a store system in conjunction with an information processing device, the information processing device configured to correlate charge instruction information of electronic money with a mobile terminal and store the charge instruction information when a predetermined condition holds between a balance of the electronic money and a price calculated every time a purchased commodity is registered, the control method comprising:
receiving a payment instruction from the mobile terminal; and
selecting, when receiving the payment instruction from the mobile terminal not correlated with the charge instruction information, a payment mode for receiving an input of data concerning payment, and
selecting, when receiving the payment instruction from the mobile terminal correlated with the charge instruction information, a charge mode for receiving an input of data concerning charging of the electronic money.

13. The control method of claim 12, further comprising:
when a difference obtained by subtracting the price from the balance of the electronic money is equal to or less than a set amount or less than the set amount, correlating the charge instruction information of the electronic money with the mobile terminal and storing the charge instruction information.

14. A control method for an information processing device, comprising:
acquiring a balance of electronic money;
calculating a price every time a purchased commodity is registered; and
correlating charge instruction information of the electronic money with a mobile terminal and storing the charge instruction information when a predetermined condition holds between the balance of the electronic money and the price.
